(19) United States
(12) Patent Application Publication
(10) Pub. No.: US 2017/0364509 A1
(43) Pub. Date: Dec. 21, 2017

(54) CONFIGURATION THAT PROVIDES AN AUGMENTED VIDEO REMOTE LANGUAGE INTERPRETATION/TRANSLATION SESSION

(71) Applicant: Language Line Services, Inc., Monterey, CA (US)

(72) Inventors: Jeffrey Cordell, Carmel, CA (US); James Boutcher, Carmel, CA (US); Lindsay D'Penha, Carmel, CA (US)

(73) Assignee: Language Line Services, Inc., Monterey, CA (US)

(21) Appl. No.: 15/184,881

(22) Filed: Jun. 16, 2016

(51) Int. Cl. G06F 17/28; H04B 1/3827; H04L 29/06; H04L 29/08

(52) U.S. Cl. CPC G06F 17/289; H04L 67/306; H04B 1/3827; H04L 65/1069; H04L 65/403

(57) ABSTRACT

A computer implemented language interpretation/translation platform is provided. The computer implemented language interpretation/translation platform comprises a processor that establishes a video remote interpretation session between a mobile device associated with a user and a computing device associated with a language interpreter/translator, receives data corresponding to a context of the video remote interpretation session from the mobile device, and augments the video remote interpretation session with one or more features that are distinct from a language interpretation service.

### BACKGROUND

### 1. Field

This disclosure generally relates to the field of language interpretation/translation. More particularly, the disclosure relates to computer implemented language interpretation/translation platforms that provide language interpretation/translation services via video-based communication.

### 2. General Background

A variety of computer implemented language interpretation/translation platforms, which shall be referred to as language interpretation/translation platforms, may be utilized to receive requests for language interpretation/translations services. Such language interpretation/translation platforms may also provide or provide access to language interpretation/translations services.

During the language interpretation/translation session provided by such systems, information is provided by the user to assist the language interpreter/translator in performing the language interpretation/translation. The language interpretation/translation session is typically limited based on the information provided by the user.

Yet, such information may not provide the full context to the language interpreter/translator. For example, if a language interpreter/translator relies only on information received from the user during an emergency situation, the language interpreter/translator may not be utilizing more important information that would help the user alleviate the emergency situation. Therefore, such systems are limited to providing language interpretation/translation based on information received from the user even though more important information may be necessary to provide an effective language interpretation that benefits the user. As a result, such systems do not provide optimal user experiences for language interpretation/translation.

### SUMMARY

A computer implemented language interpretation/translation platform is provided. The computer implemented language interpretation/translation platform comprises a processor that establishes a video remote interpretation session between a mobile device associated with a user and a computing device associated with a language interpreter/translator, receives data corresponding to a context of the video remote interpretation session from the mobile device, and augments the video remote interpretation session with one or more features that are distinct from a language interpretation service.

A computer program product is also provided. The computer program product comprises a non-transitory computer readable storage device having a computer readable program stored thereon. When executed on a computer, the computer readable program causes the computer to establish a video remote interpretation session between a mobile device associated with a user and a computing device associated with a language interpreter/translator. Further, when executed on the computer, the readable program causes the computer to receive data corresponding to a context of the video remote interpretation session from the mobile device. In addition, when executed on the computer, the readable program causes the computer to augment the video remote interpretation session with one or more features that are distinct from a language interpretation service.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a computer implemented language interpretation/translation system.

FIG. 2 illustrates the internal components of the mobile computing device illustrated in FIG. 1.

FIG. 3 illustrates an example of a session interface displayed by the input/output (“I/O”) device of the mobile computing device illustrated in FIG. 2 that is augmented with a features window.

FIG. 4 illustrates an alternative computer implemented language interpretation/translation system to that of the computer implemented language interpretation/translation system illustrated in FIG. 1.

FIG. 5 illustrates the internal components of the augmentation engine illustrated in FIGS. 1 and 4.

FIG. 6 illustrates a process that may be utilized to augment a language interpretation/translation session with one or more features.

### DETAILED DESCRIPTION

A configuration that provides an augmented video language interpretation/translation session, which may also be referred to as video remote interpretation (“VRI”), is provided. VRI allows a user to communicate with a language interpreter/translator via a video communication session between devices that have video communication capabilities. As a result, the VRI session allows for certain visual cues, e.g., facial expressions, body movements, etc., that help emphasize or de-emphasize spoken words conveyed during the communication session.

The configuration utilizes the capabilities of a mobile device corresponding to a user to augment a VRI session to enhance the language interpretation/translation with one or more features. For instance, a context of the language interpretation/translation session, e.g., geographical location, may be determined via the mobile device of the user. As another example, personal preferences of the user may be stored in mobile device of the user and may be determined from that mobile device. The configuration may utilize that context to determine particular features with which to augment the VRI session.

The configuration solves the technology-based problem of obtaining contextual data for a VRI session other than imagery of the participants. For example, a VRI session presents the user with video of the language interpreter/translator and presents the language interpreter/translator video of the user. The VRI session is typically limited to data based upon the imagery and audio of the participants and the backgrounds in proximity to those participants. The configuration may automatically obtain such data independent of an input provided by the user associated with the mobile device. For example, one or more devices positioned within the mobile device may determine the contextual data. Such automatic determination of contextual data is necessarily rooted in technology as the user may be unaware of the contextual data and/or may be unable to obtain such contextual data in a manner that allows for effective augmentation of the VRI session, e.g., delivery to and display at the device utilized by the language interpreter/translator.

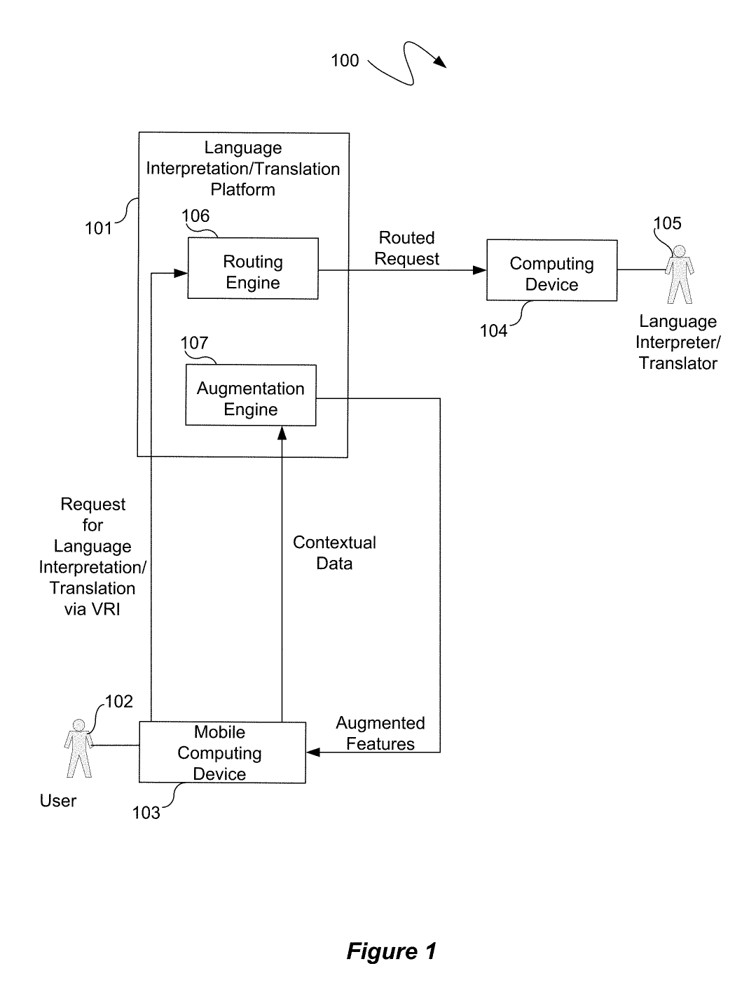

FIG. 1 illustrates a computer implemented language interpretation/translation system 100. The computer implemented language interpretation/translation system 100 has a language interpretation/translation platform 101 that establishes a VRI session between a user 102 and a language interpreter/translator 105.

For instance, one or more users 102 associated with a mobile computing device 103 may send a request from the mobile computing device 103 to the language interpretation/translation platform 101 to initiate a VRI session. The VRI session provides an interpretation/translation from a first spoken human language, e.g., Spanish, into a second spoken human language, e.g., English. For example, multiple users 102 speaking different languages may utilize the speakerphone functionality of the mobile computing device 103 to speak with a language interpreter/translator 105 provided via the language interpretation/translation platform 101 to interpret/translate the conversation according to a video modality. As another example, multiple users 102 with different mobile computing devices 103 may each communicate with the language interpretation/translation platform 101 to participate in a VRI session with the language interpreter/translator 105. As yet another example, one user 102 utilizing the mobile computing device 103 may request language interpretation/translation.

The mobile computing device 103 may be a smartphone, tablet device, smart wearable device, laptop, etc. that is capable of establishing a VRI session with the computing device 104 associated with the language interpreter/translator 105. In one embodiment, the mobile computing device 103 has one or more capabilities for determining the context in which the mobile computing device 103 is being utilized by the user 102 to request language interpretation/translation via the VRI session. For instance, the mobile computing device 103 may have a location tracking device, e.g., Global Positioning System (“GPS”) tracker, that determines the geographical location of the mobile computing device 103 during the language interpretation/translation session. In another embodiment, the mobile computing device 103 has one or more data capture devices, e.g., an image capture device such as a camera, an audio capture device such as an audio recorder, a vital statistics monitor such as a heart rate monitor, an activity tracker that tracks the number of steps walked, etc. Various sensors such as accelerometers, gyroscopes, thermometers, etc., may be utilized to detect data associated with the user 102 and/or data associated with environmental conditions in the environment in which the user 102 is located. The mobile computing device 103 may be configured to automatically perform data capture. Alternatively, the mobile computing device 103 may perform data capture based upon an input received from the user 102.

In one embodiment, the language interpretation/translation platform 101 has a routing engine 106 that routes the request for language interpretation/translation via VRI from the mobile computing device 103 to the computing device 104 associated with the language interpreter/translator 105. The computing device 104 may be a fixed workstation such as a personal computer (“PC”) or may be a mobile computing device. For example, the language interpreter/translator 105 may work at a workstation in a call center or may work from an alternative location, e.g., home, coffee shop, etc., via a mobile computing device.

In one embodiment, the language interpreter/translator 105 is a human. In another embodiment, the language interpreter/translator 105 is a computer implemented apparatus that automatically performs language interpretation/translation.

In various embodiments, the language interpretation/translation platform 101 also has an augmentation engine 107 to which the mobile computing device 103 sends the contextual data. Based on the contextual data, the augmentation engine 107 determines features that may be utilized to augment the VRI session.

The mobile computing device 103 may be configured or may have code stored thereon to configure the mobile computing device 103 to automatically send certain contextual data to the augmentation engine 107 during the VRI session. For example, the mobile computing device 103 may automatically send GPS coordinates of the user 102 during the language interpretation/translation session to the augmentation engine 107. The language interpretation/translation platform 101 may then correlate the real time location of the user 102 with external data feeds, e.g., news coverage of events at or in proximity to the location of the user 102. The augmentation engine 107 may then send such data to the mobile computing device 103, e.g., via a pop up message, a link to the news coverage, an image, a video, etc. As a result, the user 102 is able to receive additional data that may not be readily apparent to the user 102. The user 102 may then utilize such additional data during the VRI session as part of the communication with the language interpreter/translator. As a result, the user 102 may more effectively obtain a more optimal response to the basis for the language interpretation/translation, e.g., request for help in an emergency situation, avoiding traffic congestion, etc.

Alternatively, or in addition, the computing device 104 associated with the language interpreter/translator may receive the contextual data. The language interpreter/translator 105 may then utilize the contextual data to better understand the context of the request for language interpretation/translation to provide a more effective language interpretation/translation to the user 102. The language interpreter/translator 105 may provide a recommendation to the augmentation engine 107 to augment the VRI session with a particular feature based on analysis performed by the language interpreter/translator 105 and/or the computing device 104 as to which features are most pertinent for augmentation for the context.

As an example, the augmentation engine 107 may generate popup messages to be sent to the mobile computing device 103 based on the contextual data and particular words or phrases spoken during the language interpretation/translation session. In other words, the augmentation engine 107 may be configured to automatically generate a particular popup message based on a particular context and a particular keyword that occurs during the language interpretation/translation session. For instance, the mobile computing device 103 may send contextual data to the augmentation engine 107 that indicates the GPS coordinates of the user 102. The user 102 may also state during the language interpretation/translation session that the user 102 is hungry. The augmentation engine 107 may access a map from an external data feed to determine restaurants that are in proximity to the user 102 and send a popup message to the user 102 of available restaurants in proximity to the user 102. In one embodiment, the popup message is displayed in a user interface rendered by a display device of or in operable communication with the mobile computing device 103 that corresponds to the language VRI session. In another embodiment, the mobile computing device 103 has code stored thereon that generates a message center for various popup messages received from the augmentation engine 107.

As another example, the user 102 may perform image, video, or audio capture with the mobile computing device 103. The mobile computing device 103 may then automatically send the captured images, videos, or audio to the augmentation engine 107 to perform an analysis. The augmentation engine 107 may then automatically perform the analysis and/or request that the language interpreter/translator 105 perform the analysis. For instance, facial recognition, object recognition, and speech recognition may be utilized to determine the contents of the captured data. Further, the augmentation engine 107 may then generate augmented features based upon the analyzed data. For example, the augmentation engine 107 may analyze a video feed received from the mobile computing device 103 to determine an optimal path of egress for the user 102. The augmentation engine 107 may send a popup message with egress instructions, send an image with a map that highlights the path of egress, send the egress instructions to the computing device 104 so that the language interpreter/translator may interpret/translate instructions for the user 102 to egress the location of the emergency situation, etc.

The features may be images, video, audio, and/or text that are provided to the mobile computing device 103 to enhance the VRI before, during, or after the VRI. Further, the features may be services that are displayed by the mobile computing device 103 that may be ordered via the mobile computing device 103. For example, the feature may be a food delivery service that is in proximity to the user 102 that the user 102 may utilize to order food during the language interpretation/translation session.

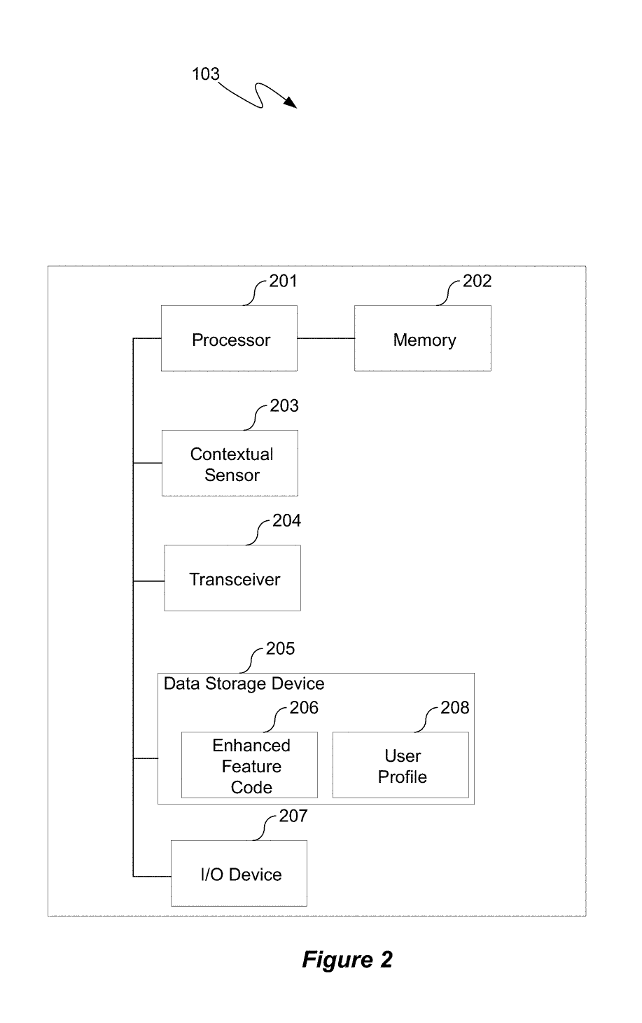

FIG. 2 illustrates the internal components of the mobile computing device 103 illustrated in FIG. 1. The mobile computing device 103 may have a processor 201 that stores computer readable instructions in a memory 202 for execution by the processor 201. The processor 201 may be in operable communication with a variety of contextual sensors 203, e.g., location tracker, environmental measurement device, accelerometer, gyroscope, etc. Further, the processor 201 may be in operable communication with a transceiver 204 that is configured to send contextual data and receive enhancement features that augment the language interpretation/translation session. The transceiver 204 may be utilized as a telephony device to send and receive voice communications from and at the mobile computing device 103. Further, the transceiver 204 may be utilized to send and receive contextual data. The mobile computing device 103 also has a data storage device 205 that stores enhanced feature code 206. The data storage device 205 may additionally, or alternatively, store a user profile corresponding to the user 102.

In one embodiment, the processor 201 is a specialized processor that is configured to execute the enhanced feature code 206 to render enhanced features received from the language interpretation/translation platform 101 on an I/O device 207, e.g., display screen. The specialized processor utilizes data received from the contextual sensor 203 in conjunction with the enhanced feature code 206 to generate enhanced features. In another embodiment, the processor 201 is a general multi-purpose processor.

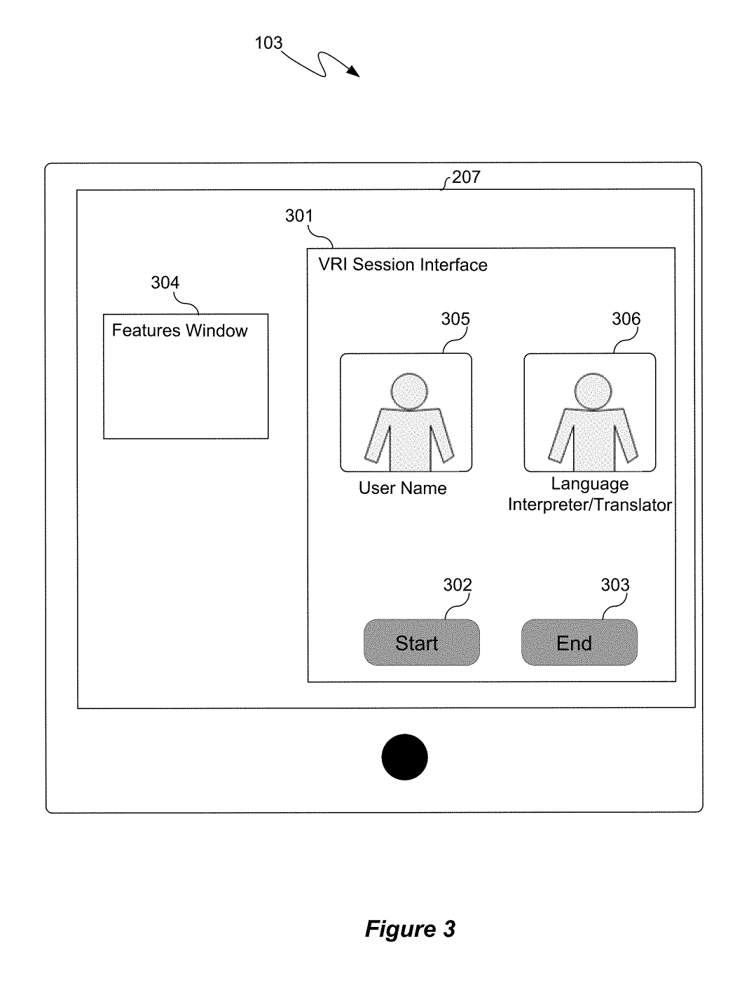

FIG. 3 illustrates an example of a VRI session interface 301 displayed by the I/O device 207 of the mobile computing device 103 illustrated in FIG. 2 that is augmented with a features window 304. In one embodiment, the I/O device 207, e.g., display screen, displays the VRI session interface 301. The session interface 301 may allow the user 102 illustrated in FIG. 1 to start the VRI session via a start indicium 302, end the VRI session via an end indicium 303, and/or implement various commands via other indicia or methodologies. The VRI session interface 301 may also display a video window 306 so that the user 102 may view the language interpreter/translator 105 during the VRI session. Further, the VRI session interface 301 may display a video window 305 so that the user 102 may view the video of the user 102 that is being viewed by the language interpreter/translator 105. The VRI session interface 301 may also provide various session details such as the names of the user 102 and the language interpreter/translator 105, the locations of the participants, etc.

The features window 304 may display various features that augment the VRI session interface 301. The transceiver 204 of the mobile computing device 103 illustrated in FIG. 1 receives the features for augmentation, and the processor 201 utilizes the enhanced feature code 206 to render the features in the features window 304. For example, the features window 304 may be a message center window that displays various messages that the user 102 may open to receive additional data that is distinct from the language interpretation service, i.e., messages with suggested restaurants, stores, etc., based upon the geographical location of the user 102. The features window 304 may also display other types of data such as images, videos, etc. that depict additional data that are distinct from the language interpretation service.

In another embodiment, the features received from the augmentation engine 107 augment the session interface 301 window without a features window 304. In other words, the processor 201 utilizes the enhanced feature code 206 to enhance the VRI session interface 301 window with the augmented features. For example, popup messages, images, videos, and other features may be placed within the VRI session interface 301 window.

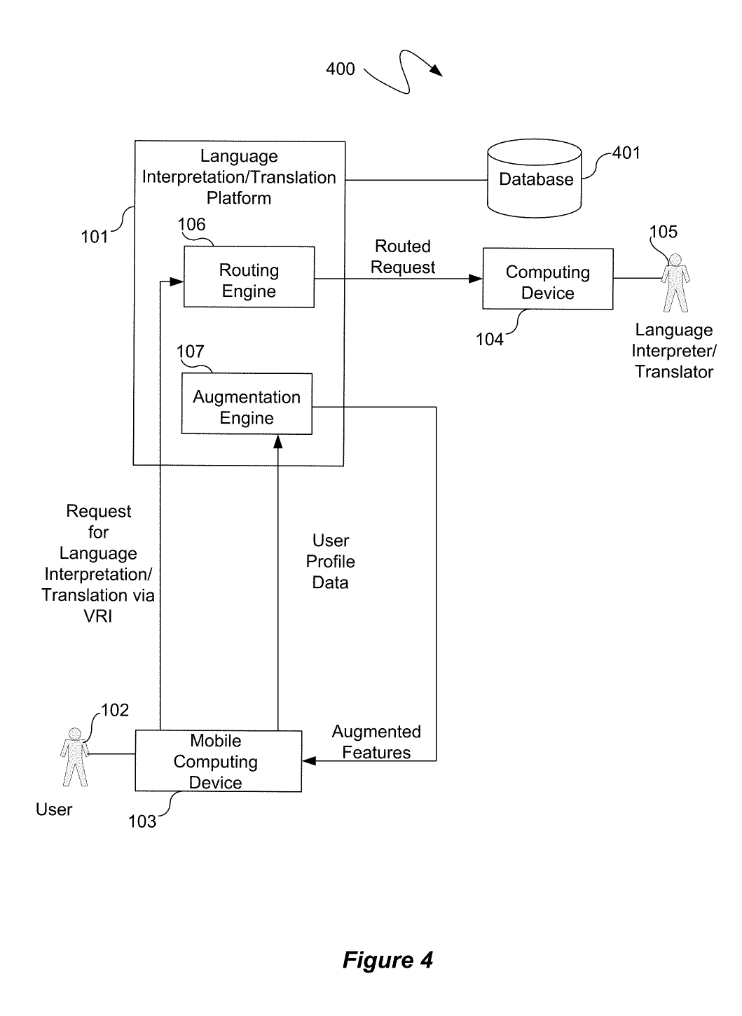

FIG. 4 illustrates an alternative computer implemented language interpretation/translation system 400 to that of the computer implemented language interpretation/translation system 100 illustrated in FIG. 1. Instead of utilizing the various capabilities of the mobile computing device 103 to determine contextual data, the alternative computer implemented language interpretation/translation system 400 utilizes the user profile 208 stored by the data storage device 205 illustrated in FIG. 2 of the mobile computing device 103. Accordingly, the transceiver 204 automatically sends user profile data, e.g., spoken languages, demographics, hobbies, interests, etc., to the augmentation engine 107. The augmentation engine 107 then utilizes the user profile data to generate the augmented features based on the user profile data. For example, the user profile 208 of the user 102 may list foods of interest so that the augmentation engine 107 may search for and provide restaurant suggestions to the user 102 without the user having to provide any input. As a result, the user 102 may concentrate on the content of the communication rather than have to ask questions pertaining to restaurant suggestions. The augmentation engine 107 may then send the features to the mobile computing device 103 for display by the I/O device 207.

In addition, or in the alternative, the alternative computer implemented language interpretation/translation system 400 may be in operable communication with a database 401. In one embodiment, the database 401 may have additional data regarding the context of the language interpretation/translation session. For instance, the user 102 may tell the language interpreter/translator 105 that the user 102 is present in a particular building. The augmentation engine 107 may then retrieve the schematics of that building and send the schematics to the mobile computing device 103 as an augmented feature of the VRI session. The user 102 may then utilize the schematics to determine an optimal path of egress from the building in an emergency situation during the VRI session with the assistance of the language interpreter/translator 105.

A combination or sub-combination of the configurations illustrated in FIGS. 1 and 4 may also be utilized. For example, the mobile computing device 103 may send contextual data based upon sensor readings in addition to user profile data. For instance, the contextual data may provide GPS coordinates of the user 102, and the user profile may indicate that the user 102 prefers a particular type of food. The augmentation engine 107 may then automatically search the database 401 for restaurants in proximity to the user 102 and generate a popup message that informs the user 102 of such restaurants during the language interpretation/translation session. The user 102 may then proceed to one of those restaurants to dine during or after the language interpretation/translation session is completed.

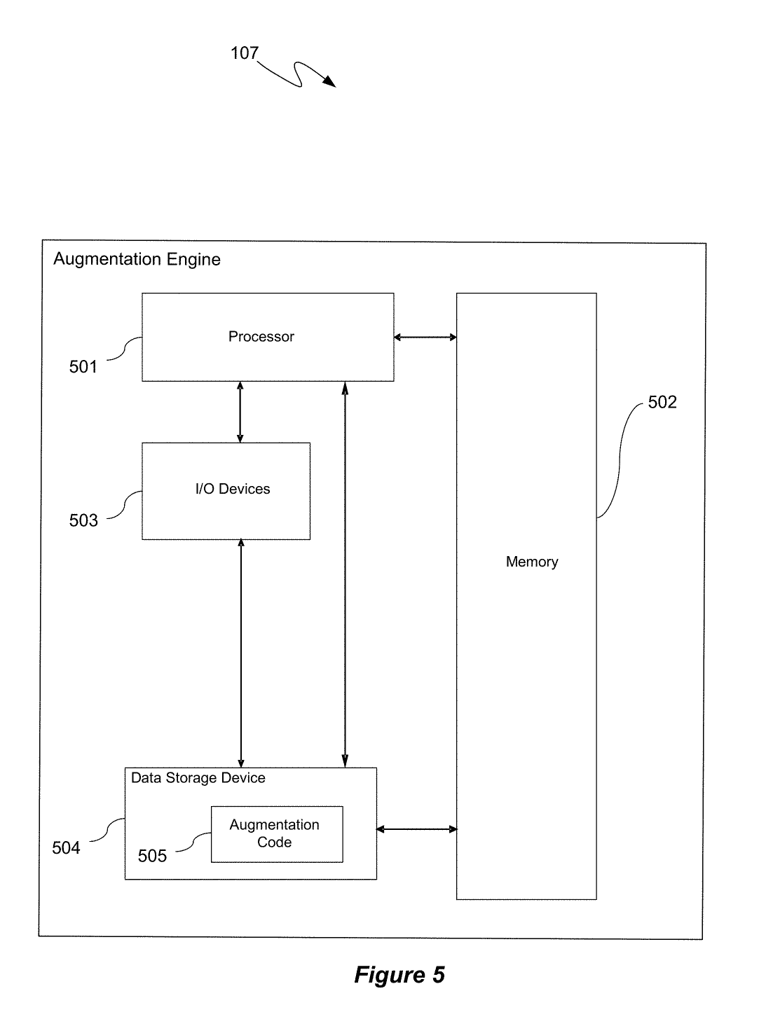

FIG. 5 illustrates the internal components of the augmentation engine 107 illustrated in FIGS. 1 and 4. In one embodiment, the augmentation engine 107 is implemented utilizing a specialized processor that is configured to automatically generate features that may be sent to the mobile computing device 103 for augmentation with a VRI session. The augmentation engine 107 comprises a processor 501, a memory 502, e.g., random access memory (“RAM”) and/or read only memory (“ROM”), various input/output devices 503, e.g., a receiver, a transmitter, a user input device, a speaker, an image capture device, an audio capture device, etc., a data storage device 504, and augmentation code 505 stored on the data storage device 504. The augmentation code 505 is utilized by the processor 502 to generate features based upon contextual data and/or user profile data. In another embodiment, the augmentation engine 107 is implemented utilizing a general multi-purpose processor.

The enhanced feature code 206 illustrated in FIG. 2 and/or the augmentation code 505 illustrated in FIG. 5 may be represented by one or more software applications or a combination of software and hardware, e.g., using application specific integrated circuits (“ASIC”), where the software is loaded from a storage device such as a magnetic or optical drive, diskette, or non-volatile memory and operated by a processor 302 in a memory of a computing device. As such, the enhanced feature code 206 illustrated in FIG. 2 and/or the augmentation code 505 illustrated in FIG. 5 and associated data structures may be stored on a computer readable medium such as a computer readable storage device, e.g., RAM memory, magnetic or optical drive or diskette, etc. The augmentation engine 107 may be utilized for a hardware implementation of any of the configurations provided herein.

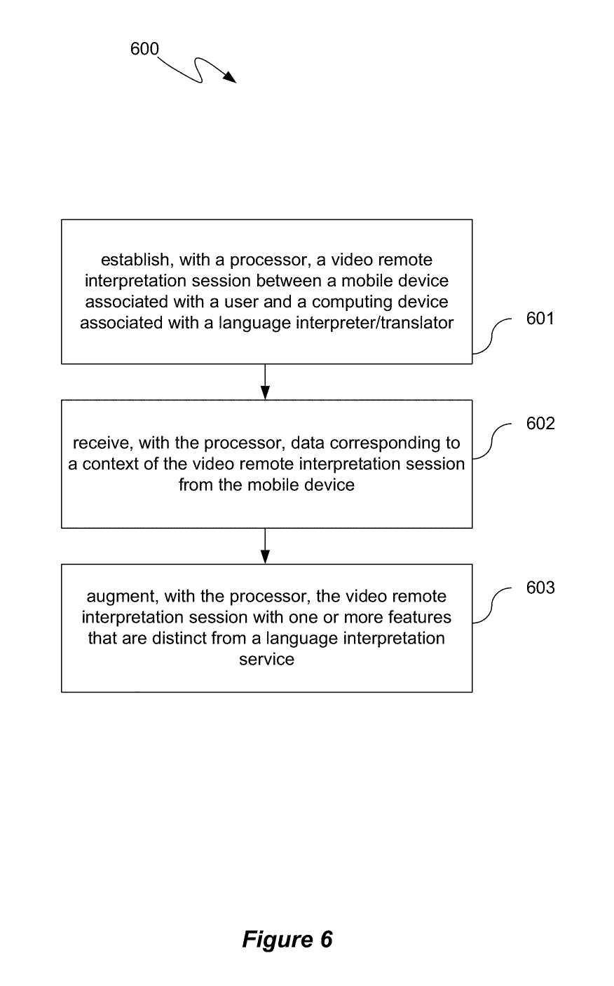

FIG. 6 illustrates a process 600 that may be utilized to augment a language interpretation/translation session with one or more features. At a process block 601, the process 600 establishes, with a processor, a video remote interpretation session between a mobile device associated with a user and a computing device associated with a language interpreter/translator. Further, at a process block 602, the process 600 receives, with the processor, data corresponding to a context of the video remote interpretation session from the mobile device. In addition, at a process block 603, the process 600 augments, with the processor, the video remote interpretation session with one or more features that are distinct from a language interpretation service.

The processes described herein may be implemented in a specialized processor that is specifically configured to augment a language interpretation/translation session with one or more features. Alternatively, such processes may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc.

A computer is herein intended to include any device that has a general, multi-purpose or single purpose processor as described above. For example, a computer may be a PC, laptop computer, set top box, cell phone, smartphone, tablet device, smart wearable device, portable media player, video player, etc.

It is understood that the computer program products, apparatuses, systems, and processes described herein may also be applied in other types of apparatuses, systems, and processes. Those skilled in the art will appreciate that the various adaptations and modifications of the embodiments of the compute program products, apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

1. A computer implemented language interpretation/translation platform comprising:
a processor that establishes a video remote interpretation session between a mobile device associated with a user and a computing device associated with a language interpreter/translator, receives data corresponding to a context of the video remote interpretation session from the mobile device, and augments the video remote interpretation session with one or more features that are distinct from delivery of a language interpretation service, the data being distinct from delivery of the language interpretation session.

2. The computer implemented language interpretation/translation platform of claim 1, wherein the data indicates a location of the mobile device based on GPS coordinates.

3. The computer implemented language interpretation/translation platform of claim 2, wherein the one or more features are based on the location of the mobile device.

4. The computer implemented language interpretation/translation platform of claim 1, wherein the data includes at least a portion of a user profile corresponding to the user.

5. The computer implemented language interpretation/translation platform of claim 4, wherein the one or more features are based on the user profile.

6. The computer implemented language interpretation/translation platform of claim 1, wherein the processor receives additional data from a database that is stored on a device that is distinct from the mobile device.

7. The computer implemented language interpretation/translation platform of claim 1, wherein the processor further automatically generates at least one popup message corresponding to the one or more features and sends the at least one popup message to the mobile device.

8. The computer implemented language interpretation/translation platform of claim 7, wherein the automatic generation of the at least one popup message is performed based on at least one of: content during a live real time implementation of the language interpretation session and data from a user profile corresponding to the user.

9. The computer implemented language interpretation/translation platform of claim 1, wherein the data is captured by the mobile device during the language interpretation session, the data being from the group consisting of: video, image, audio, and text.

10. A computer program product comprising a non-transitory computer readable storage device having a computer readable program stored thereon, wherein the computer readable program when executed on a computer causes the computer to:
establish a video remote interpretation session between a mobile device associated with a user and a computing device associated with a language interpreter/translator;
receive data corresponding to a context of the video remote interpretation session from the mobile device, the data being distinct from delivery of a language interpretation session; and
augment the video remote interpretation session with one or more features that are distinct from delivery of the language interpretation service.

11. The computer program product of claim 10, wherein the data indicates a location of the mobile device based on GPS coordinates.

12. The computer program product of claim 11, wherein the one or more features are based on the location of the mobile device.

13. The computer program product of claim 10, wherein the data includes at least a portion of a user profile corresponding to the user.

14. The computer program product of claim 13, wherein the one or more features are based on the user profile.

15. The computer program product of claim 10, wherein the computer is further caused to receive additional data from a database that is stored on a device that is distinct from the mobile device.

16. The computer program product of claim 10, wherein the computer is further caused to automatically generate at least one popup message corresponding to the one or more features and sends the at least one popup message to the mobile device.

17. The computer program product of claim 16, wherein the automatic generation of the at least one popup message is performed based on at least one of: content during a live real time implementation of the language interpretation session and data from a user profile corresponding to the user.

18. The computer program product of claim 10, wherein the data is captured by the mobile device during the language interpretation session, the data being from the group consisting of: video, image, audio, and text.

19. The computer program product of claim 10, wherein the data indicates an environmental condition in a geographic location at which the mobile device is located.

20. The computer program product of claim 19, wherein the one or more features are based on the environmental condition.
